(19) United States
(12) Patent Application Publication
(10) Pub. No.: US 2006/0265494 A1
(43) Pub. Date: Nov. 23, 2006

(54) Home network simulation system and method

(75) Inventors: O-shik Kwon, Seoul (KR); Sun-hyung Kim, Seoul (KR); Kwan-woo Song, Yongin-si (KR); Chang-nam Chu, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/397,708

(22) Filed: Apr. 5, 2006

(30) Foreign Application Priority Data
May 4, 2005 (KR) 10-2005-0037670

(51) Int. Cl. G01M 19/00; G06F 19/00

(52) U.S. Cl. 709/224; 702/122

(57) ABSTRACT

A home network simulation system and method are provided. The home network simulation system includes an area managing server that manages an area where a device corresponding to a control message input by a user resides, a gateway connected with the device in the area so that communication between the area managing server and the device can be conducted, and a device managing apparatus that sends the control message sent via the gateway to a device object corresponding to the device and generates and sends a response message corresponding to the received control message via the gateway to the area managing server.

### CROSS-REFERENCE TO RELATED APPLICATION

This application claims priority from Korean Patent Application No. 10-2005-0037670 filed on May 4, 2005, in the Korean Intellectual Property Office, the disclosure of which is incorporated herein in its entirety by reference.

### BACKGROUND OF THE INVENTION

1. Field of the Invention

Systems and methods consistent with the present invention relate to home network simulation, and more particularly, to home network simulation by which a home network can be simply tested when the home network exists.

2. Description of the Related Art

Home networking is a technology enabling communication between humans, apparatuses, and a human and an apparatus, by interconnecting digital electronic appliances in a home by a network, controlling the home appliances simply without limitations to space and kind of the device used through the communications, and receiving provision of more extensive and various services, thereby enhancing a persons quality of life.

If home networking becomes prevalent, a user would be able to look in his/her house from the outside or remotely control home appliances, such as control lighting apparatuses, or turn on an air-conditioner through a wireless terminal and the Internet. In addition, enhanced security of life would be possible by a high-tech theft and disaster prevention system.

FIG. 1 illustrates a configuration of a conventional home network system.

Referring to FIG. 1, the conventional home network system comprises a client 10 to input a control message so that a user can control a digital home appliance (hereinafter referred to as a “device”), an area managing server 20 that manages an area where a device 40 targeted to be controlled by a user resides, and a gateway 30 in a home where a device the user actually wants to control resides and that sends the control message to the device 40.

The client 10 refers to a graphic user interface linked to a computer connected with a wireless terminal or the Internet in order for a user to control the target device. Accordingly, the user selects a device to be controlled through the graphic user interface and then inputs a control message to control the selected device.

The area managing server 20 manages a predetermined area where a target device that a user wants to control resides, e.g., an apartment complex, in an integrated manner. The area managing server 20 analyzes the control message and selects the gateway 30 connected to a target device to be controlled by the user. The gateway 30 sends the control message to the target device 40 via a predetermined network.

The target device 40 that a user wants to control sends a response message corresponding to the control message sent via the client 10, the area managing server 20, and the gateway 30 to the gateway 30, the area managing server 20 and the client 10, i.e., in reverse order relative to the sending of the control message. Accordingly, the user receives the response message to the control message through the client 10.

In order for a user to control a predetermined device, several components such as the client 10, the area managing server 20, the gateway 30, and the device 40 are prepared.

Accordingly, in order to conduct a test after developing graphic user interfaces to control a predetermined device, the client 10, the area managing server 20, the gateway 30, and the device 40 are prepared.

However, there is often difficulty in preparing all of the components when graphic user interfaces are practically tested. Devices are continually developed and modified, therefore, it is hard to prepare all of the devices whenever new models and sizes are developed.

Korean Published Patent Application No. 2005-0015882 discloses a device for remotely managing a home device of a home network and a method therefore, specifically in connection with automatically installing and updating environment settings, without involvement by a user, if a new device is added to the home network or environment settings of an existed device are updated. However, it is difficult to apply this invention until all the components of the home network are completed.

### SUMMARY OF THE INVENTION

The present invention provides a home network simulation system and method which can test a home network even if all of the components of the home network are not completed.

According to an aspect of the present invention, there is provided a home network simulation system including an area managing server that manages an area where a device corresponding to a control message input by a user resides, a gateway connected with the device in the area so that communication between the area managing server and the device can be conducted, and a device managing apparatus that sends the control message sent via the gateway to a device object corresponding to the device and generates and sends a response message corresponding to the received control message via the gateway to the area managing server.

According to a further aspect of the present invention, there is provided a home network simulation method including sending a control message for a device that a user wants to control to a first apparatus managing an area where the device resides, sending the control message to a second apparatus able to communicate with the device and an apparatus managing the area, and sending the received control message to a device object representing information on the device and generating a response message to the received control message and sending the created response message to the first apparatus via the second apparatus.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a home network system according to a conventional art;

FIG. 2 is a block diagram of a home network simulation system according to an exemplary embodiment of the present invention;

FIG. 3 illustrates a device managing apparatus according to an exemplary embodiment of the present invention;

FIG. 4 is a flowchart illustrating a home network simulation method according to an exemplary embodiment of the present invention;

FIG. 5 is a flowchart illustrating a method for selecting a device object according to an exemplary embodiment of the present invention; and

FIG. 6 illustrates a rule for generating a device object according to an exemplary embodiment of the present invention.

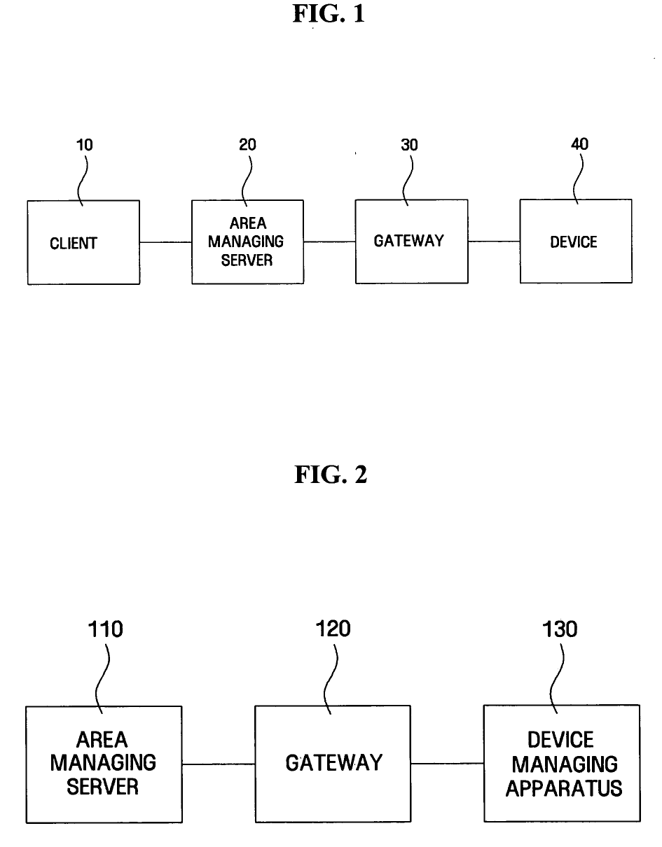

### DETAILED DESCRIPTION OF THE EXEMPLARY EMBODIMENTS

It is comprehended that specific matters of other exemplary embodiments of the present invention not disclosed herein will be implied by the detailed description and drawings.

Advantages and features of the present invention and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The present invention will be described hereinafter with reference to block diagrams or flowchart illustrations of a home network simulation system and method according to exemplary embodiments thereof. It will be understood that each block of the flowchart illustrations and combinations of blocks in the flowchart illustrations can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

Each block of the block diagrams may represent a module, segment, or portion of code, which comprises one or more executable instructions for implementing a specified logical function(s). It should also be noted that in some alternative implementations, the functions noted in the blocks may occur out of order. For example, two blocks shown in succession may in fact be executed substantially concurrently or the blocks may sometimes be executed in reverse order depending upon the functionality involved.

Exemplary embodiments of the present invention will be described with reference to the accompanying drawings.

FIG. 2 illustrates a home network simulation system according to an exemplary embodiment of the present invention.

Referring to FIG. 2, the home network simulation system includes an area managing server 110, a gateway 120, and a device managing apparatus 130.

The area managing server 110 functions to manage several devices managed by the device managing apparatus 130. A user may input a control message for a device to be controlled through an area managing server 110 and a client such as a wireless terminal connected via the Internet or a graphic user interface of a computer. The area managing server 110 may select the gateway 120 connected with the target device as a result of analyzing the input control message and send the input control message to the selected gateway 120.

The gateway 120 functions to send the control message sent from the area managing server 110 to the target device. In the present exemplary embodiment, a case that the gateway 120 analyzes a control message sent from the area managing server 110 and then sends the control message to the device managing apparatus 130 will be described as an example. At this time, it is assumed that transmission of a control message to a device targeted to be controlled by a user is conducted in the device managing apparatus 130.

The device managing apparatus 130 stores a device object corresponding to the device that the user wants to control and generates a response message to the control message sent from the gateway 120, through the stored device object. That is, the device managing apparatus 130 generates and stores a device object which is device information on a predetermined device, the device managing apparatus 130 may analyze the control message sent from the gateway 120 and selects a device object among the stored device objects according to the analysis result, and generates a response message thereto.

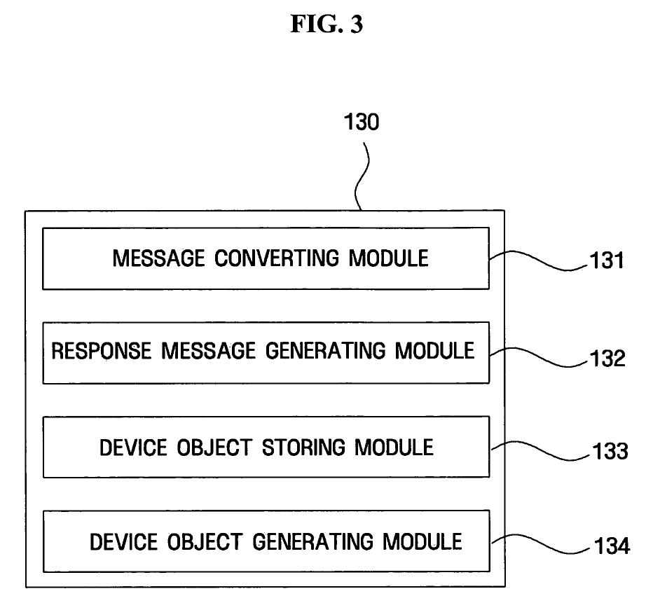

Specifically, the device managing apparatus 130, as illustrated in FIG. 3, may comprise a message converting module 131 that converts a predetermined bitstring into a key/value pair (the control message sent from the gateway 120 consists of the bitstring) and converts the key/value pair for a response message into the response message consisting of a bitstring, a response message generating module 132 that generates a key/value of a response message to a key/value pair of a control message, a device object storing module 133 that stores a device object for a predetermined device, and a device object generating module 134 that generates a device object for an added device if a new device is added.

The message converting module 131 generates a key/value pair mapped to each bit of a bitstring corresponding to a control message, through a predetermined mapping rule. For example, when a user wants to control a washer and the mapping rule is that a first bit represents whether the power is on/off and a second bit represents whether washing is on/off, the message converting module 131 converts a bitstring of the control message into the key/value pairs: “power”/“on/off” pair and “washing”/“on/off” pair.

The message converting module 131 converts a key/value pair of the response message to a bitstring response message, and then sends it to the gateway 120. At this time, the response message sent to the gateway 120 is sent via the area managing server 110 to a client in the reverse order (relative to the order of receiving the control message), so that the user can check the response message to the control message input by him/her.

The response message generating module 132 generates a key/value pair response message to a key/value pair of a received control message. The key/value pair of the generated response message may be different depending upon device objects for target devices that a user wants to control. A key/value pair of a response message generated according to each device object may be predetermined depending upon the kind of devices added, deleted, or changed by the user.

For example, when the key/value of the control message is power/on and washing/on, the response message generating module 132 determines that the user wants to control a washer, and then the response message generating module 132 generates a key/value pair corresponding to a washer among the stored device objects. The key/value pair of the generated response message is converted into a bitstring response message by the message converting module 131, and then sent to the client via the gateway 120 and the area managing server 110.

A device object stored in the device object storing module 133 is a device class for a predetermined device. In the exemplary embodiment of the present invention, a case that a device object consists of markup language such as Hyper Text Markup Language (HTML) and eXtensible Markup Language (XML) will be described as an example. The response message generating module 132 generates a key/value pair of a response message through a device object for the target device that a user wants to control, among device objects stored in the device object storing module 133.

When a user inputs a control message with respect to a newly added device, the device object generating module 134 generates a device object for the new device according to a predetermined generation rule because the response message generating module 132 cannot select a device object for the target device through the device object storing module 133. The generation rule provides a key/value pair of a response message corresponding to each key/value pairs when the control message input by the user is converted into a key/value pair in the message converting module 131. Accordingly, the device object generating module 134 may generate a device object for the target device, as predetermined according to the generation rule described above. The device object generating module 134 stores the generated device object in the device object module 133 and the response message generating module 132 may generate a key/value pair response message through the stored device object if a user inputs a control message over the device in the future.

Hereinafter, a home network simulation method according to an exemplary embodiment of the present invention will be described.

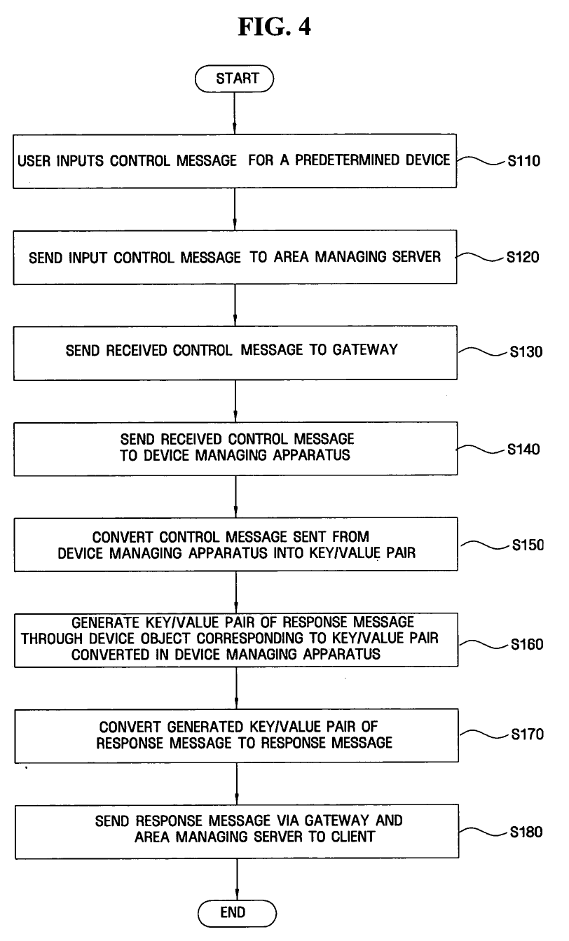

FIG. 4 is a flowchart illustrating a home network simulation method according to an exemplary embodiment of the present invention.

Referring to FIG. 4, a user inputs a control message for a predetermined device through a predetermined graphic user interface (a client) in operation S110.

The input control message is sent to the area managing server 110 in operation S120. The control message sent from the client may consist of a predetermined bitstring.

The area managing server 110 analyzes the received control message and selects the gateway 120 connected to the target device that the user wants to control and then sends the received control message to the selected gateway 120 in operation S130. In the present exemplary embodiment, it is assumed that each component is software-based, and thus, the gateway 120 selected by the area managing server 110 may also be selected according to a predetermined value.

The gateway 120 sends the control message sent by the area managing server 110 to the device managing apparatus 130 in operation S140.

The control message sent to the device managing apparatus 130 is converted into a predetermined key/value pair through the message converting module 131, according to the conversion rule described above, in operation S150.

The response message generating module 132 generates a key/value pair of a response message using the device object corresponding to a key/value pair of the converted control message in operation S160.

Then, the key/value pair of the response message generated by the response message generating module 132 is sent again to the message converting module 131, and is then converted into a response message consisting of a bitstring in operation S170.

The converted response message is sent via the gateway 120 and the area managing server 110 to a client in reverse order (relative to how the control message is sent) in operation S180.

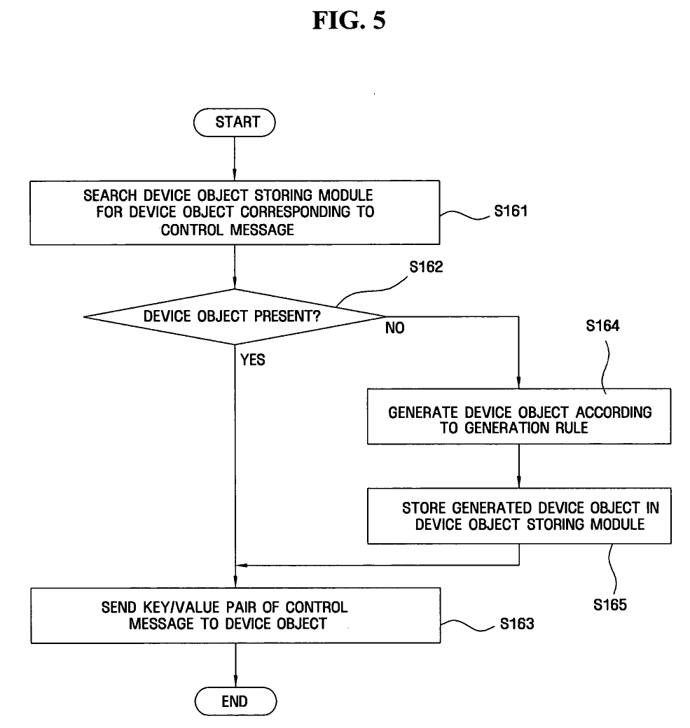

FIG. 5 is a flowchart illustrating a method for selecting a device object which a user wants to control in operation S160 of FIG. 4.

Referring to FIG. 5, the response message generating module 132 searches the device object storing module 133 for a device object corresponding to a key/value pair of the control message converted in the message converting module 131 in operation S161.

Next it is determined whether a device object corresponding to the target device that a user wants to control is present in operation S162. If the device object is present, the converted key/value pair is sent to the found device object in operation S163.

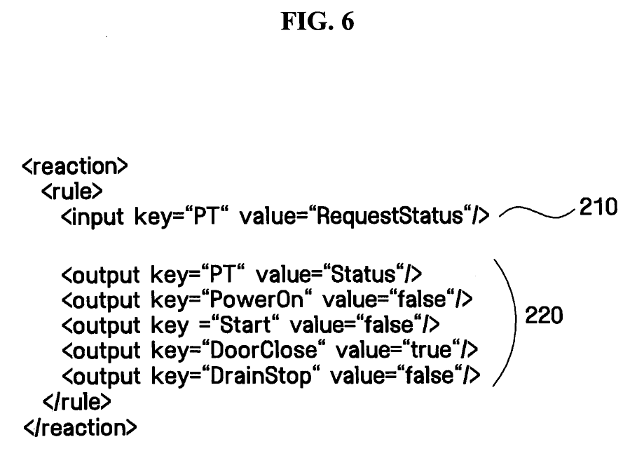

If a device object corresponding to the target device that the user wants to control is not present in the device object storing module 133, the response message generating module 132 generates a device object according to the generation rule in operation S164. According to the generation rule, the device object generating module 134 may generate a device object for the target device through a key/value pair 210 of the control message and a key/value pair 220 of the response message, as depicted in FIG. 6.

The generated device object is stored in the device object storing module 133 in operation S165. Accordingly, when a user controls the target device in the future, (s)he will be able to use the stored device object.

In the exemplary embodiment of the present invention described below, a “module” indicates a software component or a hardware component such as a field-programmable gate array (FPGA) or an application-specific integrated circuit (ASIC). The module performs a particular function and may be included in an addressable storage medium or configured to execute on one or more processors. Accordingly, modules may include components such as software components, object-oriented software components, class components and task components, processes, functions, attributes, procedures, subroutines, segments of program code, drivers, firmware, microcode, circuits, data, databases, data structures, tables, arrays, and parameters. Components and features provided by the modules may be combined into a smaller number of components and features, or they may be divided into a greater number of components and features.

As described above, the home network simulation system and method according to the exemplary embodiments of the present invention have one or more effects described below.

First, a home network can be easily tested even though all the components needed to construct the home network have not been completed.

Second, when a new device is added to the home network, a test with respect to various device models and specifications can be conducted by generating a device object corresponding to the added device.

Those skilled in the art will appreciate that many variations and modifications can be made to the home network simulation system and method according to the exemplary embodiments without substantially departing from the principles of the present invention. Therefore, the disclosed exemplary embodiments of the invention are used in a generic and descriptive sense only and not for purposes of limitation.

What is claimed is:

1. A home network simulation system comprising:
an area managing server that manages an area where a device, corresponding to a control message, resides;
a gateway connected with the device in the area so that communication between the area managing server and the device can be conducted; and
a device managing apparatus that sends the control message sent via the gateway to a first device object corresponding to the device and generates and sends a response message corresponding to the received control message via the gateway to the area managing server.

2. The system of claim 1, wherein the device managing apparatus comprises:
a device object storing module that stores the first device object comprising information on the device;
a response message generating module that selects the first device object of the device corresponding to the control message among the stored device objects and generates a first response message in response to the control message through the selected first device object;
a device object generating module that generates a second device object if the selected first device object of the device corresponding to the control message is not present.

3. The system of claim 2, wherein the device managing apparatus further comprises a message converting module that converts the control message comprising a predetermined bitstring into a key, which is a device function that at least one of the first device object and the second device object can understand, and a value, which is a state of the key.

4. The system of claim 3, wherein the first response message generating module generates a second key and value pair of the first response message corresponding to a first key and value pair of the control message.

5. The system of claim 4, wherein the message converting module converts the generated second key and value pair of the first response message into a second response message comprising a predetermined bitstring.

6. The system of claim 2, wherein the first device object stored in the device object storing module is a device class comprising a markup language generated according to information of the device.

7. The system of claim 2, wherein the device object generating module generates the second device object through a second key and value pair of the response message corresponding to a first key and value pair of the control message, and stores the generated second device object in the device object storing module.

8. A home network simulation method comprising:
sending a control message for a device to be controlled to a first apparatus managing an area where the device resides;
sending the control message to a second apparatus able to communicate with the device and the first apparatus managing the area; and
sending the received control message to a first device object representing information on the device and generating a first response message to the received control message and sending the first response message to the first apparatus via the second apparatus.

9. The method of claim 8, further comprising storing the first device object by a third apparatus.

10. The method of claim 9, wherein generating the response message comprises:
converting the control message comprising a predetermined bitstring into a key, which is a function of the device that the device object can understand, and a value, which is a state of the key;
selecting the first device object corresponding to a first converted key and value pair among a plurality of stored device objects; and
generating a second key and value pair of the first response message corresponding to the control message through the selected device object.

11. The method of claim 9, wherein the stored device object is a device class comprising a markup language according to information on the device.

12. The method of claim 10, wherein selecting the first device object comprises generating a second device object through the second key and value pair of the first response message corresponding to the first key and value of the control message if the first device object corresponding to the first key and value pair of the control message is not present, and
storing the generated second device object.

13. The method of claim 10, further comprising:
converting the generated second key and value pair of the response message into a second response message comprising a predetermined bitstring; and
transmitting the converted second response message.

14. A computer-implemented home network simulation method, the method comprising:
sending a control message for a device to be controlled to a first apparatus managing an area where the device resides;
sending the control message to a second apparatus able to communicate with the device and the first apparatus managing the area; and
sending the received control message to a first device object representing information on the device and generating a first response message to the received control message and sending the first response message to the first apparatus via the second apparatus.
